(19) United States
(12) Patent Application Publication
(10) Pub. No.: US 2010/0182316 A1
(43) Pub. Date: Jul. 22, 2010

(54) GEOSPATIAL MODELING SYSTEM FOR 3D CLUTTER DATA AND RELATED METHODS

(75) Inventors: Morteza Akbari, Rockledge, FL (US); Mark Rahmes, Melbourne, FL (US)

Correspondence Address: ALLEN, DYER, DOPPELT, MILBRATH & GILCHRIST, 255 S ORANGE AVENUE, SUITE 1401, ORLANDO, FL, 32801, US

(73) Assignee: Harris Corporation, Melbourne, FL (US)

(21) Appl. No.: 12/357,529

(22) Filed: Jan. 22, 2009

(51) Int. Cl. G06T 15/20

(52) U.S. Cl. 345/427

(57) ABSTRACT

A geospatial modeling system may include a geospatial model database having stored therein an initial three-dimensional (3D) digital surface model of a geographical area, and two-dimensional (2D) clutter data files for respective different types of possible non-building clutter. The geospatial modeling system may also include a processor cooperating with the geospatial model database to generate an updated digital surface model including 3D clutter data within and being based upon the initial digital surface model and the 2D clutter data files.

### FIELD OF THE INVENTION

The present invention relates to the field of geospatial modeling, and, more particularly, to geospatial modeling of digital surface models and related methods.

### BACKGROUND OF THE INVENTION

Topographical models of geographical areas may be used for many applications. For example, topographical models may be used in flight simulators and other planning missions. Furthermore, topographical models of man-made structures, for example, cities, may be extremely helpful in applications, such as, cellular antenna placement, urban planning, disaster preparedness and analysis, and mapping.

Various types of topographical models are presently being used. One common topographical model is a digital elevation model (DEM). The DEM is a sampled matrix representation of a geographical area, which may be generated in an automated fashion by a computer. In the DEM, coordinate points are made to correspond with a height value. DEMs are typically used for modeling terrain where the transitions between different elevations, for example, valleys, mountains, are generally smooth from one to a next. That is, a basic DEM typically models terrain as a plurality of curved surfaces and any discontinuities therebetween are thus “smoothed” over. Another common topographical model is a digital surface model (DSM). The DSM is similar the DEM but may be considered as further including details regarding buildings, vegetation, and roads, in addition to information relating to terrain.

U.S. Pat. No. 6,654,690 to Rahmes et al., which is assigned to the assignee of the present application, and is hereby incorporated herein in its entirety by reference, discloses an automated method for making a topographical model of an area including terrain and buildings thereon based upon randomly spaced data of elevation versus position. The method includes processing the randomly spaced data to generate gridded data of elevation versus position conforming to a predetermined position grid, processing the gridded data to distinguish building data from terrain data, and performing polygon extraction for the building data to make the topographical model of the area including terrain and buildings thereon.

In certain planning applications, for example, wireless communication system deployment, data describing the ground occupancy above the terrain is used, i.e. clutter data. In these applications, the clutter data is typically used for radio frequency propagation analysis. The clutter data is typically organized in a plurality of classes, for example, dense trees, sparse trees, agriculture, industrial, urban, and dense urban. Each of the classes of clutter data has corresponding propagation information, such as, height, diffraction factor, and absorption.

Typical clutter data includes two-dimensional (2D) heights, which may result in non-optimal analysis. There are some disclosed methods for inserting three-dimensional (3D) height data into 2D clutter data. For example, the 3D height data may be collected in the field, or the clutter objects in large models may be manually attributed with 3D data. These approaches may be time consuming and tedious. More specifically, this type of 3D rendering for 2D clutter objects may be lengthy and expensive since the modeler renders the object in 3D, locates the clutter areas, and determines where the rendered object correlates in the 2D space.

For example, U.S. Pat. No. 7,298,316 to Tsai et al. discloses a device for detecting clutter blocks and an interference source for dynamically establishing a 2D clutter map. The device may include a clutter block detecting module for accumulating a plurality of range cell data of each detecting area and for comparing the accumulated value with a clutter block level to define the position of a clutter block. The device may also include an interference source detecting module for accumulating all range cell data in each radar beam area and for comparing the accumulated value with an interference source reference level to detect whether any interference source exists. The device also includes a clutter map establishing module for saving the clutter maps on different beam areas in three memory blocks.

### SUMMARY OF THE INVENTION

In view of the foregoing background, it is therefore an object of the present invention to provide a geospatial modeling system for providing accurate three-dimensional (3D) clutter information.

This and other objects, features, and advantages in accordance with the present invention are provided by a geospatial modeling system comprising a geospatial model database having stored therein an initial 3D digital surface model (DSM) of a geographical area, and a plurality of two-dimensional (2D) clutter data files for respective different types of possible non-building clutter. The geospatial modeling system may also include a processor cooperating with the geospatial model database to generate an updated DSM including therein 3D clutter data based upon the initial DSM and the 2D clutter data files. Advantageously, the geospatial modeling system readily provides 3D clutter data with the DSM.

In some embodiments, the processor may further cooperate with the geospatial model database to generate the updated DSM including therein 3D clutter data by at least generating a bare earth digital terrain model (DTM) from the initial DSM, and combining the 2D clutter data files with the bare earth DTM. Moreover, the processor may further generate height histogram data and combine the 2D clutter data files with the bare earth DTM using the height histogram data.

More specifically, the geospatial model database may store the 2D clutter data files comprising 2D clutter data files associated with at least one of trees, agriculture, industrial development, and urban development. Also, the geospatial model database may store the 2D clutter data files with each of the 2D clutter data files comprising a number of vertices. The 3D clutter data may have a desired detail value based upon the number of vertices. The processor may further cooperate with the geospatial model database to generate the updated DSM including therein 3D clutter data having at least one of a minimum height value, a maximum height value, a mean height value, a standard deviation value, a base height value, an area value, a slope valuer a width value, and a length value.

In some embodiments, the geospatial modeling system may further comprise a display coupled to the geospatial model database and the processor to display the updated DSM. The processor may further cooperate with the geospatial model database to generate the initial DSM using image correlation on aerial earth images.

Another aspect is directed to a computer implemented method for modeling an initial 3D DSM of a geographical area and a plurality of 2D clutter data files for respective different types of possible non-building clutter. The computer implemented method may include generating an updated DSM including therein 3D clutter data based upon the initial DSM and the 2D clutter data files.

### BRIEF DESCRIPTION OF THE DRAWINGS

FIG. 1A is a schematic diagram of a geospatial modeling system according to the present invention.

FIG. 1B is a more detailed schematic diagram of the geospatial modeling system of FIG. 1A.

FIG. 2 is a flowchart illustrating a computer implemented method for geospatial modeling according to the present invention.

FIG. 3 is a computer display screen print image of a 2D clutter map for input into the geospatial modeling system of FIGS. 1A and 1B.

FIG. 4 is a computer display screen print image of an updated DSM produced by the geospatial modeling system of FIGS. 1A and 1B.

FIG. 5 is an enlarged portion of the computer display screen print image of FIG. 4.

FIG. 6 is a more detailed version of the computer display screen print image of FIG. 5.

FIG. 7 is a yet further enlarged portion of the computer display screen print image of FIG. 5 with coniferous 3D clutter data highlighted.

FIG. 8 is a computer display screen print image of an initial DSM for input into the geospatial modeling system of FIGS. 1A and 1B.

FIG. 9 is a schematic block diagram of a geospatial modeling system according to the present invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

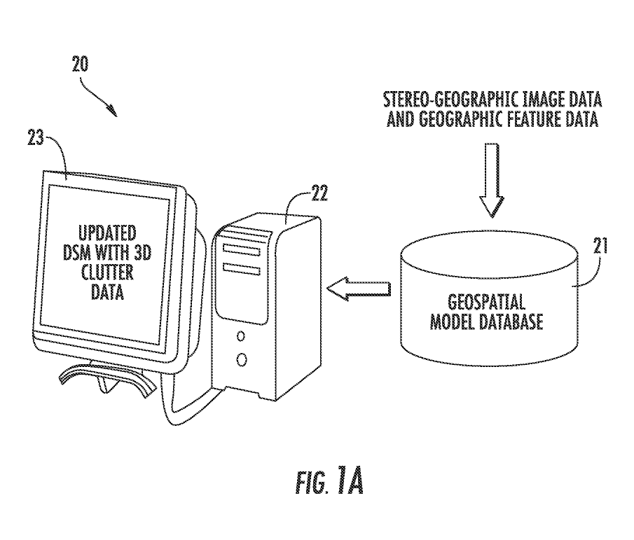

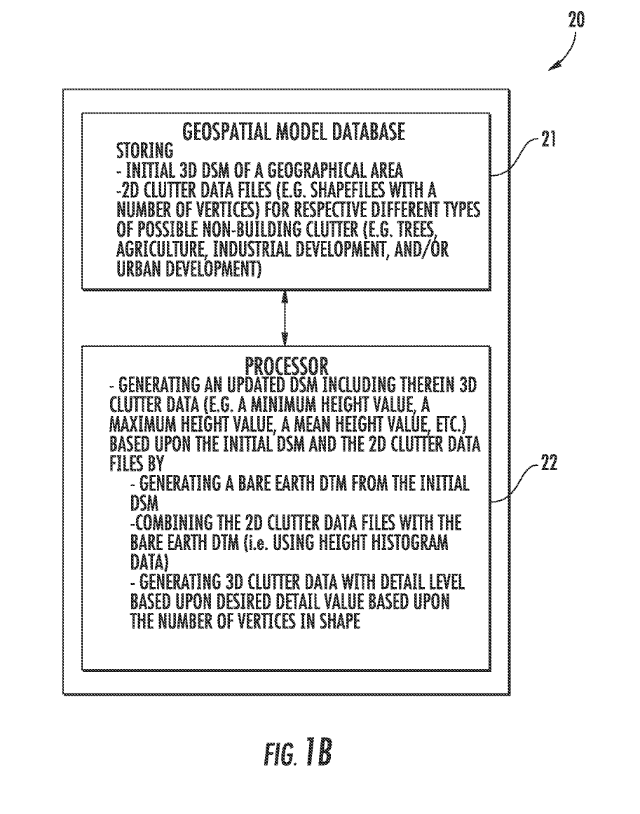

Referring initially to FIGS. 1A, 1B, and 2, a geospatial modeling system 20 according to the present invention is now described. Moreover, with reference to the flowchart 30 of FIG. 2, another aspect directed to a computer implemented method for geospatial modeling is also now described, which begins at Block 31. The geospatial modeling system 20 illustratively includes a geospatial model database 21, a processor 22, illustrated as a personal computer (FIG. 1A), coupled thereto, and a display 23 also coupled to the processor 22. By way of example, the processor 22 may be a central processing unit (CPU) of a PC, Mac, or other computing workstation.

The geospatial model database 21 illustratively stores at Block 33 an initial three-dimensional (3D) digital surface model (DSM) of a geographical area, and a plurality of two-dimensional (2D) clutter data files for respective different types of possible non-building clutter As will be appreciated by those skilled in the art, the 2D clutter data files comprise at least land use clutter data and land cover clutter data.

For example, the 2D clutter data files may comprise shapefiles. In certain embodiments, the geospatial modeling database 21 may generate the initial DSM using image correlation on aerial earth images, for example. In yet other embodiments, the processor 22 may generate the initial DSM using the method disclosed in U.S. Patent Application Publication No. 2007/0265781 to Nemethy et al., also assigned to the assignee of the present invention, and the entire contents of which are incorporated by reference herein.

At Block 35, the processor 22 further illustratively cooperates with the geospatial model database 21 for generating a bare earth digital terrain model (DTM) from the initial DSM, and combining at Block 37 the 2D clutter data files with the bare earth DTM. Once the processor 22 has combined the 2D clutter files with the bare earth DTM, the processor illustratively cooperates with the geospatial model database 21 for generating an updated DSM including therein 3D clutter data based upon the initial DSM and the 2D clutter data files. (Block 39). Advantageously, the geospatial modeling system 20 automatically provides quick and accessible 3D clutter data without the cumbersomeness and cost of typical methods.

The geospatial modeling system 20 may provide the updated DSM with 3D clutter data on the display 23 for advantageous viewing by the user. In certain embodiments, the processor 22 may further generate height histogram data and combine the 2D clutter data files with the bare earth OTM using the height histogram data. More specifically, statistical histogram analysis is used to determine the best clutter object height based on all the height post values within the boundary of the given object, as will be appreciated by those skilled in the art. The method ends at Block 41.

Optionally and as will be appreciated by those skilled in the art, the geospatial model database 21 may store the 2D clutter data files comprising 2D clutter data files associated with at least one of trees, agriculture, industrial development, urban development, dense urban, light urban, urban residential, suburban residential, paved areas, native forest dense, native forest medium, exotic forest dense, exotic forest medium, scrub, open areas, wetland, ice and snow, and water.

Also, in embodiments where the 2D clutter data files comprise shapefiles, the geospatial model database 21 may store the shape files with each having a number of vertices, i.e. the 2D clutter data files may have a certain level of detail. Based upon the this level of detail in the shapefiles, the geospatial modeling system 20 sets the desired level of detail for the 3D clutter data.

For example, the processor 22 may further cooperate with the geospatial model database 21 for generating the updated DSM including therein 3D clutter data having at least one of a minimum height value, a maximum height value, a mean height value, a standard deviation value, a base height value, an area value, a slope value, a width value, and a length value.

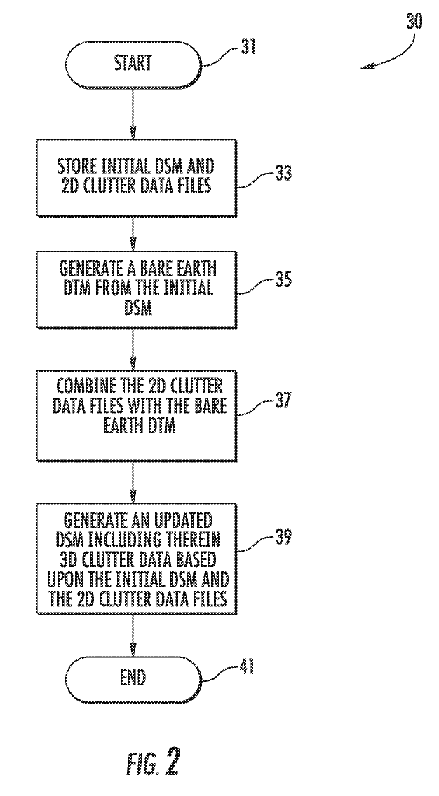

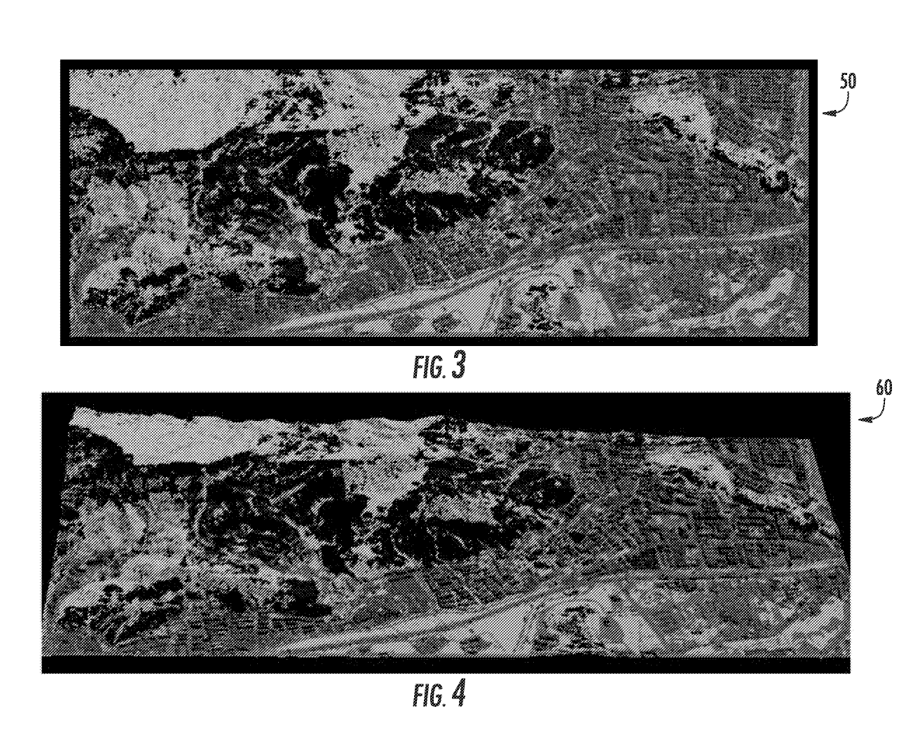

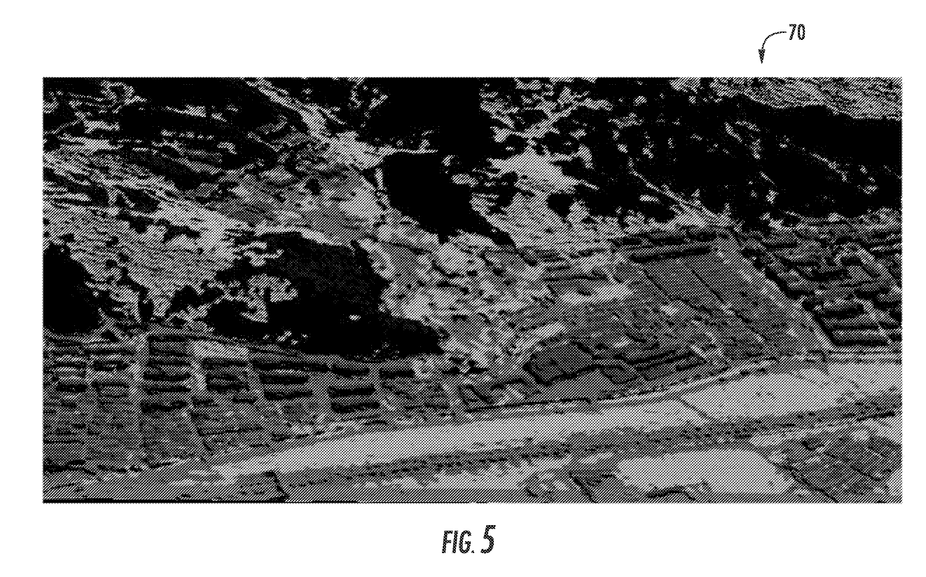

Referring now additionally to FIGS. 3-5, an image 50 (FIG. 3) illustrates an exemplary 2D image with 2D clutter data files for input into the geospatial modeling system 20. Once the image 50 is processed, an image 60 (FIG. 4) of the updated DSM counterpart is provided by the geospatial modeling system 20. Another image 70 (FIG. 5) illustrates an enlarged portion of the updated DSM image 60.

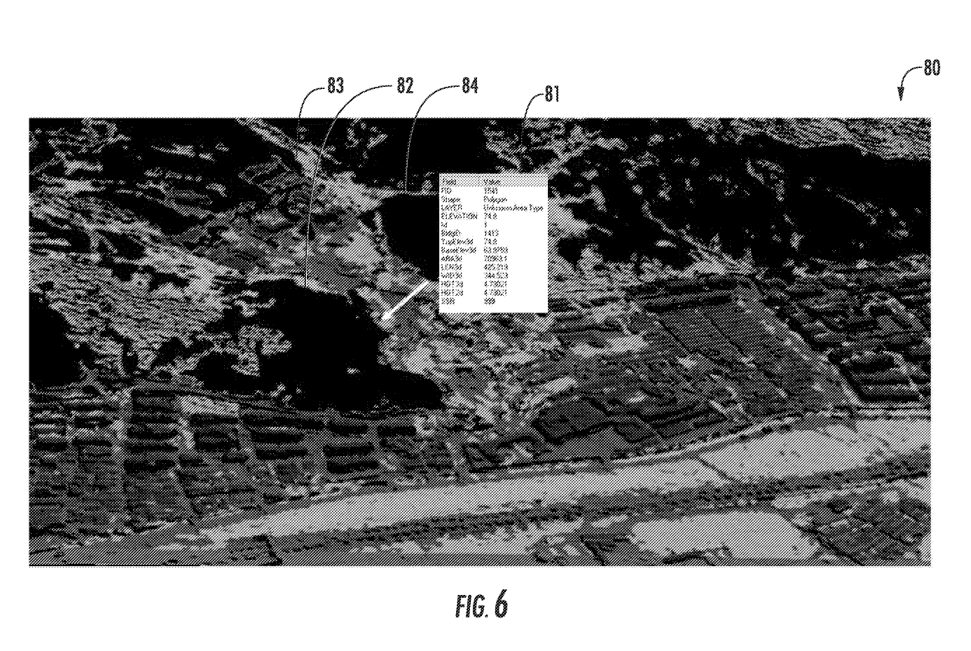

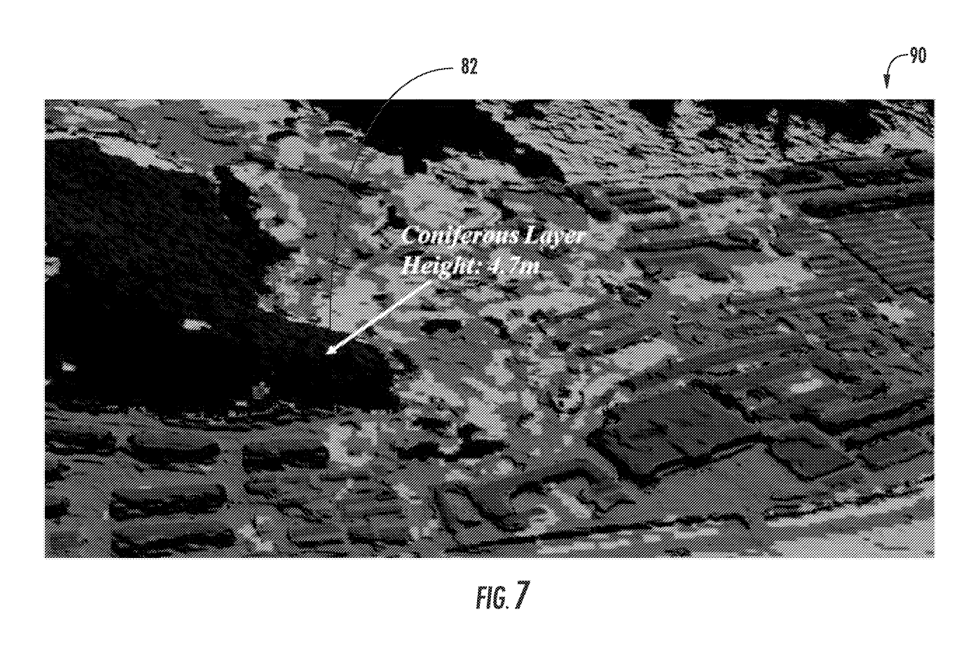

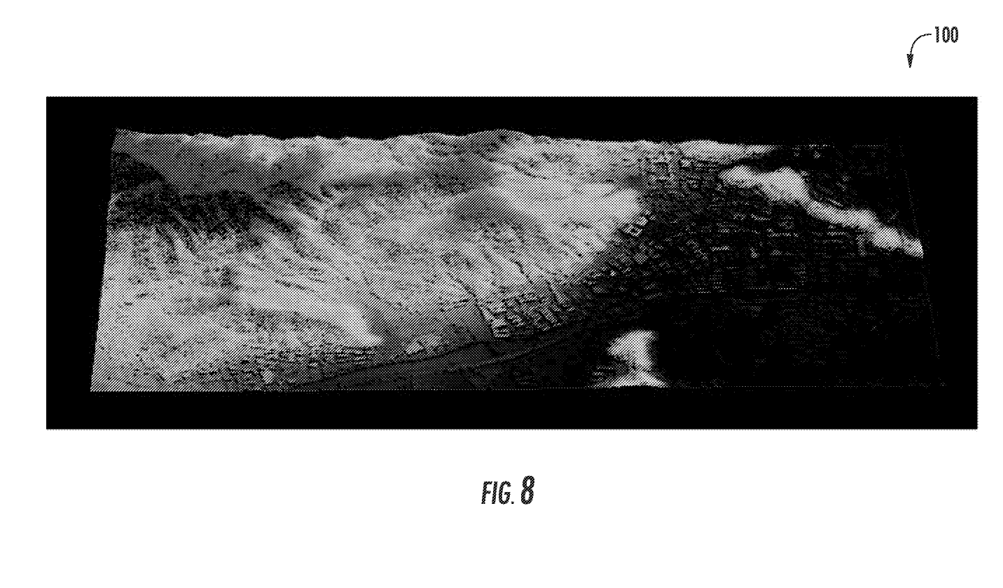

Referring now additionally to FIGS. 6-8, an image 80 (FIG. 6) illustratively includes a context menu 81 highlighting types 82-84 of 3D clutter data, which corresponds to 2D shapefiles, in the updated DSM. The context menu 81 illustratively includes data relating to feature identification number (FID), shape (polygon, line, point), layer (classification, illustrated here as unknown area type), elevation (height in meters), 3D area (length multiplied by width), 3D length (measured in meters), 3D width (measured in meters), 3D height (measured in meters above WGS84 Ellipsoid), 2D height (measured in meters above WGS84 Ellipsoid), and SSR (shape of roof—flat, pitched, or complex). Yet another image 90 (FIG. 7) shows an enlarged portion of the updated DSM image 80 where one 82 of the types 82-84 of SD clutter data is noted as a coniferous layer with a height of 4.7 meters. Another image 100 (FIG. 8) shows a detailed DSM for input into the geospatial modeling system 20.

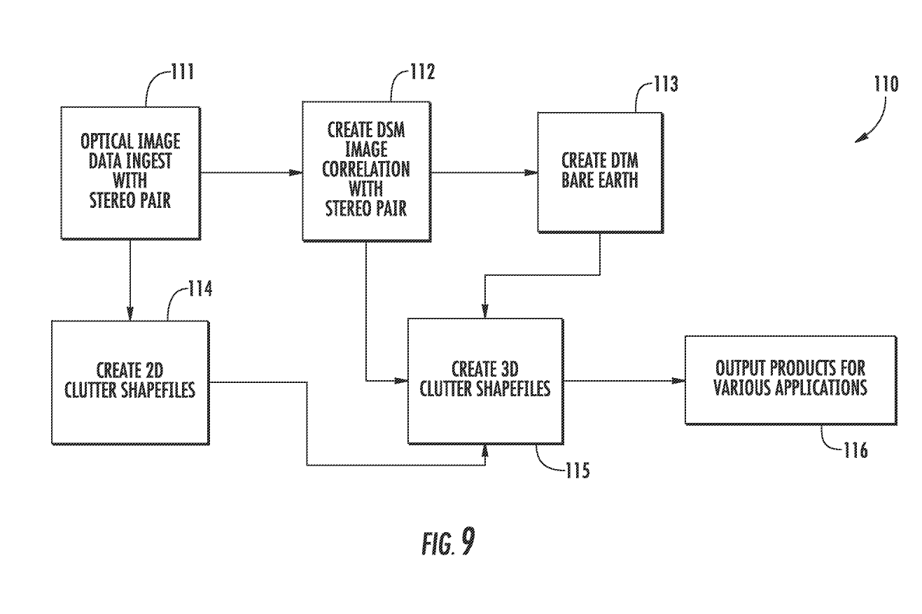

Referring now to FIG. 9, as will be appreciated by those skilled in the art, an exemplary implementation 110 of the geospatial modeling system 20 described above is now described. The exemplary geospatial modeling system 110 illustratively includes an ingest module 111 for ingesting optical image stereo pairs, for example, and a 2D clutter module 114 downstream from the ingest module for receiving an output of the ingest module. The exemplary geospatial modeling system 110 also illustratively includes an initial DSM module 112, also receiving the output of the ingest module 111, and for creating an initial DSM. The exemplary geospatial modeling system 110 illustratively includes a DTM module 113 for extracting a bare earth DTM from the initial DSM, and a 3D clutter module 115 for generating an updated DSM including therein 3D clutter data based upon the initial DSM and the 2D clutter data files. The 3D clutter module 115 receives outputs from the DTM module 113, the initial DSM module 112, and the 2D clutter module 114, and outputs to the output module 116, which as will be appreciated by those skilled in the art, may be used for other applications.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A geospatial modeling system comprising:
a geospatial model database having stored therein initial three-dimensional (3D) digital surface model of a geographical area, and a plurality of two-dimensional (2D) clutter data files for respective different types of possible non-building clutter; and
a processor cooperating with said geospatial model database to generate an updated digital surface model including therein 3D clutter data based upon the initial digital surface model and the 2D clutter data files.

2. The geospatial modeling system according to claim 1 wherein said processor further cooperates with said geospatial model database to generate the updated digital surface model including therein 3D clutter data by at least:
generating a bare earth digital terrain model from the initial digital surface model; and
combining the 2D clutter data files with the bare earth digital terrain model.

3. The geospatial modeling system according to claim 2 wherein said processor further generates height histogram data and combines the 2D clutter data files with the bare earth digital terrain model using the height histogram data.

4. The geospatial modeling system according to claim 1 wherein said geospatial model database stores the 2D clutter data files comprising 2D clutter data files associated with at least one of trees, agriculture, industrial development, and urban development.

5. The geospatial modeling system according to claim 1 wherein said geospatial model database stores the 2D clutter data files with each of the 2D clutter data files comprising a number of vertices; and wherein the 3D clutter data has a desired detail value based upon the number of vertices.

6. The geospatial modeling system according to claim 1 wherein said processor further cooperates with said geospatial model database to generate the updated digital surface model including therein 3D clutter data having at least one of a minimum height value, a maximum height value, a mean height value, a standard deviation value, a base height value, an area value, a slope value, a width value, and a length value.

7. The geospatial modeling system according to claim 1 further comprising a display coupled to said geospatial model database and said processor to display the updated digital surface model.

8. The geospatial modeling system according to claim 1 wherein said processor further cooperates with said geospatial model database to generate the initial digital surface model using image correlation on aerial earth images.

9. A geospatial modeling system comprising:
a geospatial model database having stored therein an initial three-dimensional (3D) digital surface model of a geographical area, and a plurality of two-dimensional (2D) clutter data files for respective different types of possible non-building clutter;
a processor cooperating with said geospatial model database to generate an updated digital surface model including therein 3D clutter data based upon the initial digital surface model and the 2D clutter data files by at least
generating a bare earth digital terrain model from the initial digital surface model, and
combining the 2D clutter data files with the bare earth digital terrain model; and
a display coupled to said geospatial model database and said processor to display the updated digital surface model.

10. The geospatial modeling system according to claim 9 wherein said processor further generates height histogram data and combines the 2D clutter data files with the bare earth digital terrain model using the height histogram data.

11. The geospatial modeling system according to claim 9 wherein said geospatial model database stores the 2D clutter data files comprising 2D clutter data files associated with at least one of trees, agriculture, industrial development, and urban development.

12. The geospatial modeling system according to claim 9 wherein said geospatial model database stores the 2D clutter data files with each of the 2D clutter data files comprising a number of vertices; and wherein the 3D clutter data has a desired detail value based upon the number of vertices.

13. The geospatial modeling system according to claim 9 wherein said processor further cooperates with said geospatial model database to generate the updated digital surface model including therein 3D clutter data having at least one of a minimum height value, a maximum height value, a mean height value, a standard deviation value, a base height value, an area value, a slope value, a width value, and a length value.

14. A computer implemented method for modeling an initial three-dimensional (3D) digital surface model of a geographical area and a plurality of two-dimensional (2D) clutter data files for respective different types of possible non-building clutter, the method comprising:
generating an updated digital surface model including therein 3D clutter data based upon the initial digital surface model and the 2D clutter data files.

15. The computer implemented method according to claim 14 wherein the generating of the updated digital surface model comprises:
generating a bare earth digital terrain model from the initial digital surface model; and
combining the 2D clutter data files with the bare earth digital terrain model.

16. The computer implemented method according to claim 15 further comprising:
generating height histogram data; and
combining the 2D clutter data files with the bare earth digital terrain model using the height histogram data.

17. The computer implemented method according to claim 14 wherein the 2D clutter data files comprise 2D clutter data files associated with at least one of trees, agriculture, industrial development, and urban development.

18. The computer implemented method according to claim 14 wherein each of the 2D clutter data files comprises a number of vertices; and wherein the 3D clutter data has a desired detail value based upon the number of vertices.

19. The computer implemented method according to claim 14 wherein the updated digital surface model includes therein 3D clutter data having at least one of a minimum height value, a maximum height value, a mean height value, a standard deviation value, a base height value, an area value, a slope value, a width value, and a length value.

20. The computer implemented method according to claim 14 further comprising displaying the updated digital surface model.
